(19) United States
(12) Patent Application Publication
(10) Pub. No.: US 2010/0309127 A1
(43) Pub. Date: Dec. 9, 2010

(54) MARKETING METHODS USING BRANDED, CONTENT-PRELOADED, PERIPHERAL, MEMORY-STICK PC-POINTING DEVICES

(75) Inventors: James Paul Markey, Glendale, CA (US); Daniel Thomas Cwieka, Laguna Beach, CA (US); Bob Munley, Cypress, CA (US)

Correspondence Address: STOUT, UXA, BUYAN & MULLINS LLP, 4 VENTURE, SUITE 300, IRVINE, CA, 92618, US

(73) Assignee: FOUR DOOR MEDIA, INC., Dana Point, CA (US)

(21) Appl. No.: 12/742,089

(22) PCT Filed: Nov. 7, 2008
(86) PCT No.: PCT/US08/82871

§ 371 Date: Aug. 23, 2010

Related U.S. Application Data
(60) Provisional application No. 61/002,423, filed on Nov. 7, 2007.
(60) Provisional application No. 61/036,929, filed on Mar. 15, 2008.
(60) Provisional application No. 61/075,701, filed on Jun. 25, 2008.
(60) Provisional application No. 61/076,141, filed on Jun. 26, 2008.
(60) Provisional application No. 61/076,143, filed on Jun. 27, 2008.

(51) Int. Cl. G06F 3/033

(52) U.S. Cl. 345/163

(57) ABSTRACT

A memory stick is configured to interface with a host computer by way of a Universal Serial Bus (USB) interface and to control by radio frequency (RF) a wireless mouse. The wireless mouse may take on a shape such as that of, for example, a car. An RF communication device, such as a memory stick, is provided for interfacing with the computer by the USB interface and interfacing with the wireless mouse by a wireless protocol. Both USB memory sticks are combined into one to generate a memory stick that will facilitate the running of the wireless mouse and add content as soon as the user plugs it in to the USB port of the computer. The system can be used to advertise and run applications such as games, movies and music. The memory stick can be in shape of a key for the car, with a trademarked emblem and with colors to match the color of the mouse.

### CROSS-REFERENCE TO RELATED APPLICATIONS

This application claims priority to U.S. Provisional Application No. 61/076,143 filed Jun. 27, 2008 and entitled METHODS FOR ISSUING MOCK VEHICLE CERTIFICATES FOR VEHICLE-MIMICING POINTING DEVICES (Docket 4D8123PR), U.S. Provisional Application No. 61/076,141 filed Jun. 26, 2008 and entitled POINTING DEVICE WITH FLASHING-HEADLIGHT USER INPUT VERIFICATION (Docket 4D8118PR2), U.S. Provisional Application No. 61/075,701 filed Jun. 25, 2008 and entitled POINTING DEVICE WITH FLASHING-HEADLIGHT USER INPUT VERIFICATION (Docket 4D8118PR), U.S. Provisional Application No. 61/036,929 filed Mar. 15, 2008 and entitled BUSINESS MARKETING METHODS USING BRANDED, CONTENT-PRELOADED, PERIPHERAL, MEMORY-STICK PC-POINTING DEVICES (Docket VE8091PR), and U.S. Provisional Application No. 61/002,423 filed Nov. 7, 2007 and entitled MEMORY STICK AND WIRELESS MOUSE COMBINATION (Docket VE8069PR), the entire contents of all which are hereby incorporated by reference.

### BACKGROUND OF THE INVENTION

1. Field of the Invention

This application is related to computer components and business methods implementing computer components.

2. Description of Related Art

Computer components have existed in the prior art. Such items have included, for example, computer cursor control devices; computer mice; wired, wireless, and battery-free computer mice; computer mice bearing shapes of vehicles; computer mice bearing shapes of cars; computer mice bearing shapes of cartoon or other fictional or story-line crafts; computer mouse pads; standard, custom and battery-free computer mouse pads; data storage media, memory components; and removable memories for recording and storage of information.

### SUMMARY OF THE INVENTION

A memory stick is configured to interface with a host computer by the Universal Serial Bus (USB) interface and to control by radio frequency (RF) a wireless mouse. The wireless mouse may take on a shape such as that of, for example, a car, and also has a RF communication device (memory stick) for interfacing with the computer by the USB interface and interfacing with the wireless mouse by a wireless protocol. Both USB memory sticks are combined into one to generate a memory stick that will facilitate the running of the wireless mouse and add content as soon as the user plugs it in to the USB port of the computer. The system can be used to advertise and run games, movies, songs etc. The memory stick can be in shape of a key for the car, with trademarked emblem and or with colors to match the color of the mouse.

### BRIEF DESCRIPTION OF THE DRAWING

FIG. 1 shows a replica mouse comprising a hood with a scroll-wheel and with left-click and right-click buttons on opposing sides of the scroll wheel.

### DETAILED DESCRIPTION OF THE INVENTION

Any feature or combination of features described or referenced herein are included within the scope of the present invention provided that the features included in any such combination are not mutually inconsistent as will be apparent from the context, this specification, and the knowledge of one skilled in the art. In addition, any feature or combination of features may be specifically excluded from any embodiment of the present invention. For purposes of summarizing the present invention, certain aspects, advantages and novel features of the present invention are described. Of course, it is to be understood that not necessarily all such aspects, advantages or features will be embodied in any particular implementation of the present invention. Additional advantages and aspects of the present invention are apparent in the following detailed description and additional disclosure in claims format that follow.

Reference will now be made to certain embodiments (e.g., certain illustrated embodiments) of the invention, examples of which are illustrated in the accompanying drawings. Wherever possible, the same or similar reference numbers are used in the drawings and the description to refer to the same or like parts. It should be noted that the drawings are in simplified form and are not presumed, automatically, to be to precise scale in all embodiments. That is, they are intended to be examples of implementations of various aspects of the present invention and, according to certain but not all embodiments, to be to-scale. While, according to certain implementations, the structures depicted in the FIGURE are to be interpreted to be to scale, in other implementations the same structures should not. In certain aspects of the invention, use of the same reference designator numbers in the drawings and the following description is intended to refer to similar or analogous, but not necessarily the same, components and elements. According to other aspects, use of the same reference designator numbers in these drawings and the following description is intended to be interpreted as referring to the same or substantially the same, and/or functionally the same, components and elements. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain embodiments (e.g., certain illustrated embodiments), it is to be understood that these embodiments are presented by way of example and not by way of limitation. The intent accompanying this disclosure is to discuss exemplary embodiments with the following detailed description being construed to cover all modifications, alternatives, and equivalents of the embodiments as may fall within the spirit and scope of the invention as defined by the additional disclosure in claims format. It is to be understood and appreciated that the process steps and structures described herein do not cover a complete architecture or process, and only so much of the commonly practiced features and steps are included herein as are necessary to provide an understanding of the present invention.

A business model according to the invention is based around automotive and related-themed computer mice. These wired and wireless mice are made of ABS plastic materials, RHOS compliancy with a Universal Serial Bus (USB) receiver utilizing radio frequency, rechargeable batteries, and optical technologies that may be sold with or without a mouse pad.

The licensor acquires licensing rights from automobile manufacturers to models of retail (sold for sale, or concept) cars, including the cars' image and likeness, to reproduce replicas of the cars (automobile products) on a reduced scale (i.e., the scale of a computer mouse), and with the form and functionality of computer mice. Manufacturers of automobiles and trucks can include, for example, companies bearing the trademarks and/or names of Dodge, Chrysler, Ford, GM, Nissan, Lexus, Toyota, Aston Martin, Pontiac, Saturn, Chevrolet, Porsche, and Mercedes.

The CAD data received from licensors will typically be in life-size data format, rather than in miniaturized format. The distortions & mismatches in surfaces resulting from the scaling of these surfaces/CAD data can be proportional to the scaling factor and hence the efforts required for the same. In this case of Charger mouse particularly, there can be a large number of changes in the geometry, warranted by the functional requirements of the mouse. Incorporating these changes, while keeping the licensed geometry intact, can be performed in the fashion of multiple iterations. The design and iterations should involve considerations for ergonomics requirements to enhance the design. Selection of particular models to license should be based upon market data for selection of models that are anticipated to yield higher sales volume to obtain returns sufficient to recoup initial investments on product development.

A replica car mouse (e.g., with headlights that light up) is disclosed as an accessory/peripheral—and other branded peripherals like this can constitute a separate, high volume line of business, distinct from the full replica PC products. That is, replica mice can be sold as standalones through venues such as catalog, at premium novelty pricing.

An automotive and related-themed computer replica mouse, and methods of using the same, are thus disclosed. The computer replica mouse preferably comprises one or more trademark characteristics (e.g. distinct visual resemblances) of or to a branded vehicle. Thus, the computer replica mouse can have an appearance corresponding identically to, substantially similarly to (e.g., being a replica), or closely corresponding to, or to a likeness of, the shape of an actual automobile. The wired or wireless mice can be made with a USB receiver utilizing radio frequency, rechargeable batteries, and optical technologies that may be sold with or without a mouse pad.

A seller acquires the licensing rights from vehicle manufacturers to reproduce replicas of branded, actual vehicles, and/or to related branded vehicle products, including the branded vehicles' images and likenesses. The reproductions can include replicas of the branded vehicles, and of related branded automobile products, on a reduced scale such as in the functional format of, for example, computer components such as pointing devices and mice. Vehicle manufacturers can include, for example, manufacturers of well known, branded automobiles and trucks, such as those including the names and trademarks of Dodge, Chrysler, Ford, GM, Nissan, Lexus, Toyota, Aston Martin, Pontiac, Saturn, Chevrolet, Porsche, and Mercedes.

The retail sales cost for a product can be relatively low compared to the initial expenditure (e.g., 100 or 1000 times greater) required to complete the development and manufacturing of a product. It thus can be important to select a “licensor” actual vehicle (e.g., Viper or Corvette) that will yield a higher sales volume to generate returns on the replica vehicle sufficient to recoup the initial development investment.

A USB flash memory stick can be configured to interface with a host computer and to control/provide by radio frequency (RF), such as via BlueTooth, wireless mouse functionality. The wireless replica mouse may take on a shape such as that of, for example, a car. A car-shaped wireless mouse, such as a replica mouse, can thus have a USB RF communication device (memory stick) for interfacing with the computer by the USB interface and interfacing with the wireless replica mouse by a wireless protocol such a BlueTooth. Both USB memory sticks are combined into one to generate a memory stick that will facilitate the running of the wireless mouse.

The USB memory stick facilitates running of the wireless replica mouse and adds content as soon as the user plugs it in to the USB port of the computer, “it” being the combination USB plug which contains an RF transmitter and components for interfacing with the computer to run business and/or promotional items and also run (facilitate operation of) the wireless replica mouse.

The memory stick can be in shape of a key for the car, with a trademarked emblem and or with colors to match the color of the replica mouse. The memory stick can be provided with a related purchase or sold separately (e.g., stand alone) without a wireless controller for the replica mouse. The memory stick can come with the purchase of an actual, life-size, internal combustion (i.e., “real”) car and/or with a replica mouse, in the shape of a key. For example, it can be shaped like a laser key. The owner will be instructed to keep the key, and it will be supplied with other keys on a keychain.

The owner inserts the memory stick into the USB port of a computer as if inserting a key into the ignition. It can contain information such as all factory and warranty information, owner's manual, etc. It can have memory stick functions as well.

In general, the memory stick can comprise a link to and/or the content of a registration page on which the user registers the equipment by entering a vehicle identification number (VIN) as discussed below which VIN is supplied with one or more of the memory stick and the replica mouse. The VIN is preferably printed or molded on a surface (such as an underside) of the replica mouse in connection with (e.g., following) the letters “VIN.”

The replica mouse's vehicle identification number (VIN) is the identifying code for a SPECIFIC automobile. It is just like the actual car's (or replica mouse's) fingerprint. As with a VIN for an actual car, the replica mouse VIN can be composed of 17 digits and characters that act as a unique identifier for the vehicle (or replica mouse). The VIN communicates the car's (or replica mouse's) unique actual-automobile features, specifications and manufacturer. VINs of corresponding to actual cars made before 1981 can be provided with lengths of 11 to 17 characters.

Following entry of the VIN, the owner of the replica mouse is issued a certificate of title to the replica mouse, which certificate bears the same appearance as a certificate of title to a “real” automobile of the same make and model. The VIN on the replica mouse is imprinted on the certificate of title and registration.

Additionally, the user is provided with the option of purchasing an “automobile” (or “replica mouse”) insurance policy for the replica mouse, which policy would be relatively inexpensive (e.g., about ¼ to ⅓ the retail purchase price of the replica mouse) and would be issued with a certificate of auto (or replica mouse) insurance bearing the same or similar appearance and wording as a certificate of insurance to a corresponding “real” automobile of the same make and model. For example, the VIN on the replica mouse is imprinted on the certificate of title of auto (or replica mouse) insurance. The insurance policy, while having the appearance of a policy to a “real” automobile, will cover damage to the replica mouse rather than damage to a (or the corresponding) “real” automobile. The replica mouse is referred to in the certificate of insurance, not solely as a “computer mouse” but rather by one or more of, and preferably all of: the make, model and year of the real automobile to which the replica mouse mimics, and the VIN disposed on the replica mouse.

In embodiments wherein the replica mouse corresponds to an actual, like automobile just purchased by the owner, the memory stick may further contain information on and links relating to the actual automobile, including one or more of: a dealership, a commercial or promotion for the actual automobile, memorabilia, service & warranty info, parts providers, maintenance schedules, specs on the actual automobile, lineage/history/facts info on the actual automobile; blog links, chat rooms; games (e.g., can register car online and then race or participate in road rallies online; car logs including use and/or maintenance info, and even a link to a provider of auto insurance for the actual automobile.

The memory stick can have child-proofing so that when it is inserted it blocks Internet pages that are not part of the memory stick agenda. A customer might want just the replica car. In that case, the memory stick may still contain promotional information. Also, a mouse pad can have matching indicia relating to, for example, the movie such as a scene or a character in the movie. In another embodiment, rather than an RF protocol from the memory stick to control the replica mouse, a mouse pad can be made to plug into the computer, for example, wherein the pad controls the replica mouse.

Aspects of the invention can thus include one or more of computer mice shaped like a car, added to this a receiver/memory stick/flash drive in the shape of a car ignition key, a memory stick in the shape of a ignition key that will have a logo incased, printed or tooled onto this unit, and these units can be USB connected.

A purpose of the receiver/memory stick can be to carry marketing information to potential customers, e.g., video, websites, accessories for sale within the brand (shown by one or more of the mouse, mouse pad, or memory stick), operating manuals/information about the product purchased or information about a real car purchased (e.g., recommended schedule maintenance, oil change, service, after market products, dealer promotions). For movie promotions, e.g., Batman, Bond 007, and other trademark names, the memory stick can carry movie clips, free tickets, fan club links and other information, etc. Children's toy (e.g., car-shaped) mice, can be provided/loaded with, for example, learning games.

As described herein, and according to a broad aspect of the invention, a pointing device (e.g., mouse) is provided in the shape of a vehicle. The pointer device may comprise the structure or functionality of one or more of mice, trackballs, cursor control devices, optical pads, and touchpads functioning as computer pointing devices; computer cursor control and pointing devices; wired, wireless, and battery-free computer mice; computer mice bearing shapes of cars; computer mice bearing shapes of manufactured cars; computer mice bearing shapes of cartoon or other fictional or story-line cars; computer mouse pads; standard, custom and battery-free computer mouse pads; data storage media, namely, packaged semiconductors; memory components; removable memory sticks, boards and disks for recording and storage of information; removable memory sticks, boards and disks for recording and storage of information and featuring prerecorded promotional product-related information; car-key shaped removable memory sticks, boards and disks for recording and storage of information and featuring prerecorded promotional product-related information.

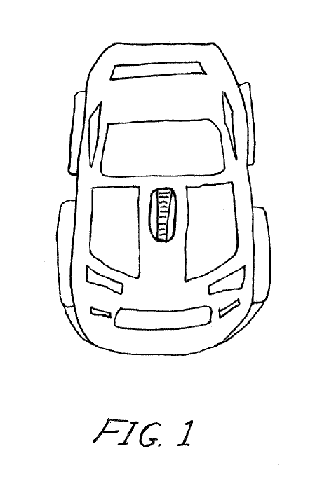

According to an exemplary implementation, the pointing device can be provided in the shape of an automobile. FIG. 1 shows a pointing device in the form of a replica mouse comprising an automobile shape. The hood comprises a scroll-wheel with left-click and right-click buttons on opposing sides of the scroll wheel.

In general, click buttons, such as left and right click buttons, are provided on the pointing device, such as on an upper, leading, and/or other anatomically convenient or operable location, of the vehicle-shaped pointing device. When the vehicle-shaped pointing device comprises an automobile shape, in which embodiment the upper, leading, and/or other anatomically convenient or operable location can comprise the hood of the automobile, other controls, such as the illustrated scroll wheel, may be provided on the pointing device. A typical embodiment includes the provision of a scroll wheel between the two (e.g., left click and right click) buttons, as elucidated in FIG. 1.

Lights and/or sound, having any structure and/or function as described herein, may be incorporated into or associated, in any combination or permutation, with one or more of the left and right click buttons, alone or as an addition to any whole or partial embodiment or combination of features described herein. In some embodiments, a pointing device can be provided with headlights and/or can be provided with click button lights. One implementation of such a configuration can comprise the provision of a pointing device with one or more of operable headlights and operable click button lights. In the below-described embodiment, a pointing device is provided in the form of a vehicle-shaped replica mouse comprising one or more of operable headlights disposed in a traditional automobile location and operable click button lights disposed on a hood of the replica mouse.

In embodiments incorporating a scroll wheel, lights and/or sound, having any structure and/or function as described herein, may be incorporated into or associated, in any combination or permutation, with the scroll wheel, alone or as an addition to any whole or partial embodiment or combination of elements described herein. Furthermore, additionally or alternatively, the scroll wheel may be provided with any click button functionality described herein, wherein, for example, pressing down or “clicking” on the scroll wheel (e.g., as if it were a click button) causes it to move downwardly and “click” like a click button (e.g., which may elicit any click-button effect described herein). In some embodiments, a pointing device (i) can be provided with a “rotational-movement scroll wheel” light, e.g., that activates or is associated with rotational movement of the scroll wheel, and/or (ii) can be provided with a “button-action scroll wheel” light, e.g., that activates or is associated with downward movement or button clicking movement of the scroll wheel. One implementation of such a configuration can comprise the provision of a pointing device with one or more of operable headlights and operable click-button lights. In the below-illustrated embodiment, a pointing device is provided in the form of a vehicle-shaped replica mouse comprising one or more of operable headlights disposed in a traditional location and operable click-button lights disposed on a hood thereof Any described light functionality may be incorporated into one or more of headlight locations/actions, hood (e.g., click button) locations, and scroll wheel locations, and/or any sound functionality described herein may be incorporated into one or more of headlight locations, hood (e.g., click button) locations, and scroll wheel locations/actions.

An on/off switch or function can be provided and operable on one or more of the pointing device, a host computer, and a remote control. Furthermore, the on/off switch or function can be provided and operable by way of one or more of a physical switch and a non-physical (e.g., voice command, key stroke, mouse movement, insertion of a memory stick such as a car-key shaped memory stick, etc.) implementation. The optional on/off switch can be provided on the pointing device, such as on a bottom of the pointing device, and, in one particular embodiment, can be activated by either movement of the switch or by a software input on the host computer.

According to one feature of the invention, when the switch is off (e.g., in a switch-off position), one or more lights on the pointing device, such as the head lights of the depicted car mouse, and/or other features depending on configuration(s) of the pointing device, remain off. This feature can operate, for example, to extend battery life of the pointing device between charges.

When the switch is on (e.g., in a switch-on position), lights on the pointing device, such as the head lights of the depicted car mouse, will, according to a preferred implementation, turn on for durations of time corresponding to the durations of time that the left or right click button(s) are depressed. In modified embodiments, depression of one of the buttons can result in low-beam headlights being activated and depression of the other of the buttons (or pressing of both together) can result in the generation of high-beam headlights being effectuated.

Instead of being configured to turn on upon the occurrence of certain events and then to automatically turn off, the lights may alternatively, or additionally, be programmed to “toggle” between states upon occurrences of the certain events. For example, toggling may occur between on and off states of the lights, and/or to toggle between (i) high beam and (ii) low beam modes, alone or in combination with (iii) switch-on/switch-off mode(s), of the pointing-device. In certain implementations, any depression of any button on the mouse can result in a toggling of the headlights between the on and off positions.

According to other embodiments, the lights (and/or the pointing device) can be programmed to remain in a certain mode (and/or operational configuration), such as an on mode, or, alternatively, an off mode, for a predetermined period of time following one or more of (a) a depression of one or more of the buttons, (b) a movement of the pointing device, and (c) a movement of a scroll wheel.

In other modified embodiments, hazard (e.g., red) lights, and/or patrol-car lights in alternative embodiments, and/or other types of lights, may be activated, e.g., to implement flashing or other types of light actions/sequences, following a certain pointing-device operation (e.g., simultaneous depression of right and left buttons), or a sequence of operations (e.g., consecutive depression of right, then left, then right buttons), or an event or combination/sequence of events.

In other embodiments, the headlights can be displayed (e.g., turn or stay on) corresponding to: 1. modes of operation, e.g., the PC being “on” and not in a sleep or stand by mode; 2. events, e.g., a screen saver not being displayed; or 3. content such as when certain (a) websites, e.g., sponsored sites, are visited or (b) email, e.g., with sponsored addresses or Subject line words are sent/received.

According to other embodiments, parking lights can be provided on the pointing device, which lights may be displayed during or following predetermined events or inputs (e.g., in connection operations by or on one or more of a remote, a host computer, and the pointer-device) such as discussed above. Displaying of parking lights (e.g., for 10 second periods) may include or be based upon the occurrence of, or following a predetermined period (e.g., 5 seconds) following the occurrence of certain modes of operation, or certain events, or certain content. For instance, bright headlights may be displayed for an initial 5 seconds following a certain event, after which time the parking lights may be displayed for 10 seconds.

Other modifications and permutations of the preceding are possible. For example, any of the above user-perceivable actions, modes, or events by or to the pointing device may alternatively, or additionally, in any permutation or combination, be initiated with a sound such as a car sound (e.g., the sound of a revving engine and/or of an auto horn) and/or a recording of a sponsored message, such as a sound bite (e.g., a 2 second recording of sponsored music or from a message or other work), or even a special offer such as a sound communicating an announcement or a discount or a coupon.

According to certain implementations, a predetermined sound (e.g., a sound as described herein) can be played one time or multiple times, corresponding to a single movement or multiple movements of the scroll wheel. A single-movement condition may comprise, for example, an initial movement (i.e., after a 5 second period of non-movement) of the scroll wheel. A multiple-movement condition may correspond, for example, to the playing of a sound upon every predetermined motion (e.g., a cm of rotational movement or one click) of the scroll wheel, or, for example, every two predetermined motions within 3 seconds (e.g., resulting in the playing of one or two sounds) of the scroll wheel. The predetermined sound, for scroll wheel implementations or for other sound implementations described herein, may comprise, for example, sounds such as the sound of a blinker (e.g., corresponding to the predetermined motions, clicking or cm rotational movements of the scroll wheel), an engine starter, a windshield wiper or windshield washer squirter, a race-track sound such as a “go” sound that begins an auto race; a bell, a brief auto horn sound, a brief sound of a screeching or skidding tire(s), to name a few.

Other modifications and permutations of the preceding are possible. For example, any combination of the described user-perceivable actions, modes, or events by and/or to the pointing device may alternatively, or additionally, in any permutation or combination, evoke a single sound or a combination of sounds corresponding, for example, to a point or points in time immediately following an occurrence of the combination of actions, modes or events.

In a modified embodiment, the device can comprise one or more of the characteristics described and/or referenced herein, but may not operate, or may not operate fully, as a pointing device. For example, a device can be operable as described herein, e.g., with activated (e.g., flashing) headlights according to the occurrence of one or more predetermined events, but may be placed on top of a computer monitor or a desktop for viewing rather than operating as a pointing device.

Corresponding or related structure and methods described in the following applications are incorporated herein by reference in their entireties, wherein such incorporation includes corresponding or related structure (and modifications thereof) in the following applications which may be, in whole or in part, (i) operable with, (ii) modified by one skilled in the art to be operable with, and/or (iii) implemented/used with or in combination with, any part(s) of the present invention according to this disclosure, that of the patents or below applications, and the knowledge and judgment of one skilled in the art: U.S. Provisional Application No. 61/036,929 filed Mar. 15, 2008 and entitled BUSINESS MARKETING METHODS USING BRANDED, CONTENT-PRELOADED, PERIPHERAL, MEMORY-STICK PC-POINTING DEVICES (Att. Docket VE8091PR), and to U.S. Provisional Application No. filed Nov. 7, 2007 and entitled MEMORY STICK AND WIRELESS MOUSE COMBINATION (Att. Docket VE8069PR).

The above-described embodiments have been provided by way of example, and the present invention is not limited to these examples. Multiple variations and modifications to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. As iterated above, any feature or combination of features described and referenced herein are included within the scope of the present invention provided that the features included in any such combination are not mutually inconsistent as will be apparent from the context, this specification, and the knowledge of one of ordinary skill in the art. For example, any of the user-perceivable actions of the pointing device, and any particulars or features thereof, or other features, including method steps and techniques, may be used with any other structure and process described or referenced herein, in whole or in part, in any combination or permutation as a non-equivalent, separate, non-interchangeable aspect of this application. Accordingly, the present invention is not intended to be limited by the disclosed embodiments, but is to be defined by such embodiments and by reference to the following claims.

1. A pointing device in the shape of a vehicle, comprising:
a façade corresponding to an appearance of a vehicle;
a control on the mouse that is activatable by a hand of a user as a pointing-device input; and
a source that is adapted to emit a user-perceivable pulse of energy following activation of the control.

2. The pointing device as set forth in claim 1, wherein the vehicle is an automobile.

3. The pointing device as set forth in claim 1, wherein the control is one or more of a right-click button and a left-click button.

4. The pointing device as set forth in claim 1, wherein the source is a light source.

5. The pointing device as set forth in claim 4, wherein the pulse of energy is a beam of light from a headlight of the vehicle.

6. The pointing device as set forth in claim 1, wherein the source is a speaker.

7. The pointing device as set forth in claim 6, wherein the pulse of energy is a prerecorded sound a moving part of an automobile.

8. The pointing device as set forth in claim 1, wherein the pulse of energy is a prerecorded message comprising words.

9. The pointing device as set forth in claim 1, wherein the pulse of energy is a prerecorded message comprising music.

10. A pointing device in the shape of a vehicle, comprising:
a body bearing a resemblance of a vehicle; and
a code disposed on the body, the code being preceded with a sequence of alphanumeric characters identifying the code as a vehicle identification number (VIN).

11. The pointing device as set forth in claim 10, wherein the vehicle is an automobile and the VIN comprises a sequence of alphanumeric characters.

12. The pointing device as set forth in claim 10, wherein the vehicle is an automobile and the VIN has from 11 to 17 digits.

13. The pointing device as set forth in claim 10, and further comprising a certificate of title and registration bearing the same VIN.

14. The pointing device as set forth in claim 10, and further comprising a web accessible record bearing the same VIN.

15. The pointing device as set forth in claim 10, and further comprising a certificate of insurance bearing the same VIN.

16. The pointing device as set forth in claim 10, and further comprising an actual automobile bearing the same VIN.
